(19) United States
(12) Patent Application Publication
(10) Pub. No.: US 2009/0053663 A1
(43) Pub. Date: Feb. 26, 2009

(54) Germ protective cake cover

(76) Inventor: Stephen R. Okros, Ocean, NJ (US)

Correspondence Address: Stephen R. Okros, 21 Oxford Drive, Ocean, NJ, 07712, US

(21) Appl. No.: 11/894,746

(22) Filed: Aug. 22, 2007

(51) Int. Cl. A47G 19/26; F21V 35/00

(52) U.S. Cl. 431/295; 312/284

(57) ABSTRACT

The present invention is a transparent dessert cover designed to shield confections, such as cakes, from germs resulting particularly from those attempting to blow out candles, while maintaining the aesthetic appearance of the cake. In the preferred mode, the cover is constructed of freezer-proof plastic material, and molded in the shape of a particular confection, such as a round or rectangular birthday cake. The upper portion of the cover contains recessed holes to accommodate a predetermined number of candles, as well as at least one slot in which a celebratory message such as “Happy Birthday” may be inserted. Importantly, individual letters are provided for the user to spell out particular names or messages, as desired. Finally, a sturdy, attachable bottom piece is provided with the cover to facilitate transportation and storage of the cake.

### BACKGROUND OF THE INVENTION

1. Field of the Invention

The present invention is a transparent dessert cover designed to shield confections, such as cakes, from germs resulting particularly from those attempting to blow out candles, while maintaining the aesthetic appearance of the cake. In the preferred mode, the cover is constructed of freezer-proof plastic material, and molded in the shape of a particular confection, such as a round or rectangular birthday cake. The upper portion of the cover contains recessed holes to accommodate a predetermined number of candles, as well as at least one slot in which a celebratory message such as “Happy Birthday” may be inserted. Importantly, individual letters are provided for the user to spell out particular names or messages, as desired. Finally, a sturdy, attachable bottom piece is provided with the cover to facilitate transportation and storage of the cake.

2. Description of the Prior Art

Numerous innovations for cake covers have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 4,938,688, Invented by Wexler, Entitled “Cake Cover and Candle Holder”

The patent to Wexler describes a transparent plastic cover for cakes which has a horizontal top and vertical sides. The top has indentations for holding candles vertically. The indentations are arranged in the form of two side-by-side rectangles with a central horizontal bar. When all the indentations are filled with candles, the number “88” is indicated. By selective filling of the indentations one can indicate any number between one and ninety-nine. The combined cake cover and candle holder permits decorating the cake with lighted candles representing a numerical celebration of a birthday, anniversary etc. The cake is protected from the candles and from the saliva from blowing out the candles.

2. U.S. Pat. No. 5,096,274, Invented by Fushetto et al., Entitled “Candle Bearing Ceremonious Cake Shield”

The Fushetto et al. invention describes a celluloid transparent cake cover, preferably disposable, that is to be placed over a circular or rectangularly shaped cake. The horizontal top of the cover contains a plurality of depressions that are intended to hold and support candles. A slotted groove is also provided in the horizontal top cover for containing and supporting known wax candle numerals. A number of aesthetically pleasing features are also incorporated including arched windows around the perimeter of the sidewalls of the cover and outward steps around the lower part of the sidewall. The cover is constructed with a plurality of adjacently placed perforations around the periphery of the lower-sidewall on the same horizontal plane. The lower section of the sidewall may be torn away at these perforations to lower the total height of the cover.

3. U.S. Pat. No. 4,884,966, Invented by Wexler, Entitled “Protective Cake Cover and Candle Holder”

The Wexler invention describes a transparent plastic cover for cakes which is rectangular in shape and is adjustable for rectangular cakes of different sizes. The top has indentations to hold candles. Stand-offs are provided to raise the cover above the icing to prevent indentations from marring the icing. The indentations can be used to mark the top of the cake as a cutting guide.

4. U.S. Pat. No. 4,721,455, Invented by Barfus, Entitled “Birthday Cake Cover and Candle Holder”

In the patent to Barfus, a cake cover and candle support a cylindrical center support configured to be inserted into a birthday cake or the like and defining a extended portion. A planar cake cover defines a center aperture and a plurality of candle receiving recesses. The cake cover is received upon and supported by the center support above the upper surface of a cake.

5. U.S. Design Pat. No. D446,083, Invented by Marsh et al., Entitled “Protective Cake Cover and Candle Holder”

The patent to Marsh et al. depicts an ornamental design for a protective cake cover and candle holder, as shown and described.

6. U.S. Design Pat. No. D403,441, Invented by Lane, Entitled “Display Unit and Candle Holder”

The patent to Lane depicts an ornamental design for a display unit and candle holder, as shown and described.

7. U.S. Design Pat. No. D337,026, Invented by Higgins, Entitled “Cake Cover”

The patent to Higgins depicts an ornamental design for a cake cover, as shown and described.

8. U.S. Design Pat. No. D333,410, Invented by Panzarello, Entitled “Birthday Sani-Cake Cover”

The patent to Panzarello depicts an ornamental design for a birthday sani-cake cover and candle holder, as shown and described.

9. U.S. Design Pat. No. D298,859, Invented by Crisci, Entitled “Combined Cake Shield and Candle Holder”

The patent to Crisci depicts an ornamental design for combined cake shield and candle holder, as shown and described.

10. U.S. Design Pat. No. D285,159, Invented by Wexler, Entitled “Combined Protective Cake Cover and Candle Holder”

The patent to Wexler depicts an ornamental design for a combined protective cake cover and candle holder, substantially as shown and described.

The aforementioned prior art patents illustrate various cake covers, some of which include candle-holding recesses. For the purposes of example, the first above-listed patent to Wexler discloses a cover with indentations in the shape of the number “88,” such that figures of all two-digit numbers may be made by selective placement of the candles.

In addition, the patent to Fuschetto discloses a decorative cake cover with candle holders and side walls, but the cover is disposable in nature, and fails to teach the usage of letters for formation of various names or sayings.

Furthermore, the patent to Barfus discloses a cake cover that holds multiple candles thereon, but the cover item must be inserted into the cake itself, thus affecting its appearance and form.

In contrast to the prior inventions, the present invention is a transparent cover that shields round or rectangular cakes from germs of those blowing out candles, which includes a slot in which a message may be inserted. In addition, the invention includes letters which function to allow the user to include the name or message of his or her choice, thus providing unique versatility. Moreover, the present cover includes a bottom member, which functions to allow the invention to act as an effective transportation and storage item.

### SUMMARY OF THE INVENTION

As noted, the present invention is a transparent dessert cover designed to shield confections, such as cakes, from germs resulting particularly from those attempting to blow out candles, while maintaining the aesthetic appearance of the cake. In the preferred mode, the cover is constructed of freezer-proof plastic material, and molded in the shape of a particular confection, such as a round or rectangular birthday cake. The upper portion of the cover contains recessed holes to accommodate a predetermined number of candles, as well as at least one slot in which a celebratory message such as “Happy Birthday” may be inserted. Importantly, individual letters are provided for the user to spell out particular names or messages, as desired. Finally, a sturdy, attachable bottom piece is provided with the cover to facilitate transportation and storage of the cake.

In light of the foregoing, it is generally an object of the present invention to provide a device that protects cakes from germs of those blowing out candles.

It is a further object of the invention to provide a item that allows for effective viewing of decorative cakes, due to its transparent cover.

It is an additional object of the invention to provide a cover with up to one hundred ten recesses in which candles may be inserted, so as to render the invention suitable for birthdays of all persons.

It is also an object of the invention to provide a item that teaches the use of a slot in which a name or celebratory message may be inserted.

It is a further object of the invention to provide a series of letters such that users can spell out the name or message of their choice for display.

It is another object of the invention to provide a cover that may be closed and completely sealed for the purpose of storing the cake, which is also freezer-proof for long-term storage.

It is a further object of the present invention to provide a cover that is relatively inexpensive to manufacture, produce, and distribute.

It is an additional object of the present invention to provide a cover that may be manufactured in a variety of shapes and sizes, so that varying versions of the cover can be used for all types of cakes and confections.

In addition, it is an object of the present invention to provide a cover that is lightweight in nature and easy for a user to transport.

It is an object of the present invention to provide a cover assembly that may include text or graphics thereon, for the purposes of enhanced decoration.

Finally, it is an object of the present invention to provide alternate embodiments of the device, wherein the invention is constructed of different materials, according to manufacturer and user needs.

The novel features which are considered characteristic for the invention are set forth in the claims. The invention itself, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

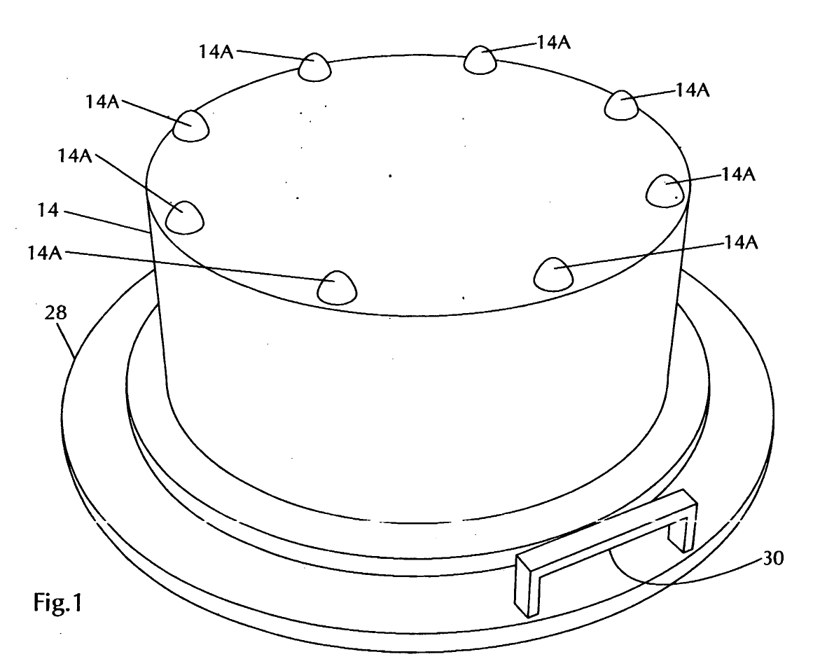

FIG. 1 is a front, three-quarter perspective view of a simple, round cake on which the cover of present invention may be placed, with the bottom piece of the invention illustrated beneath the cake. For the purposes of example, the location of common cake decorations is indicated by number 14A, and the general location of an optional lifting handle on the bottom piece is indicated by number 30.

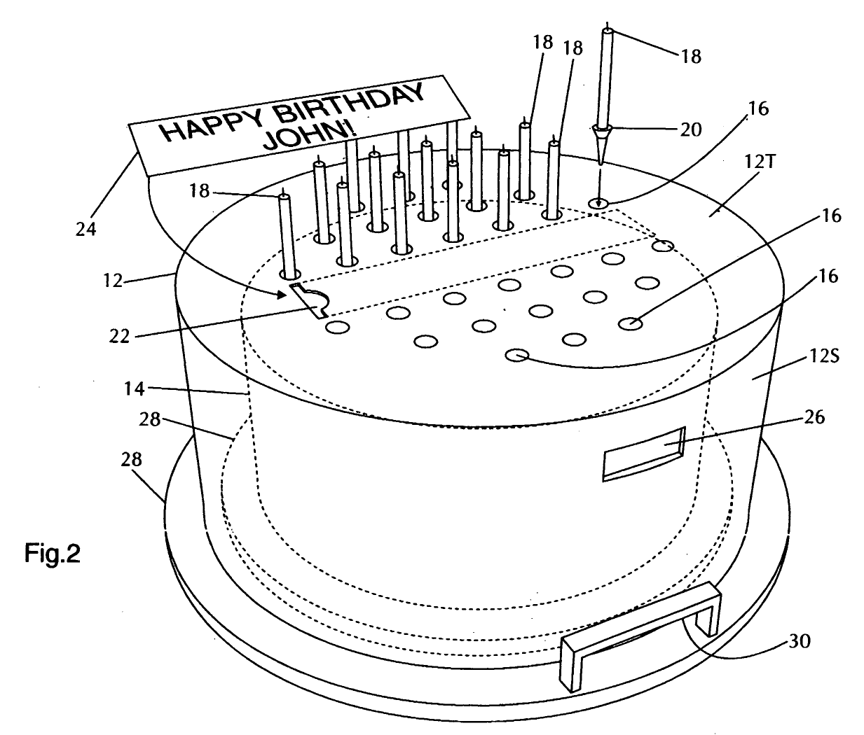

FIG. 2 is a front, three-quarter perspective view of the cake (shown in dotted lines) with the cover of the present invention placed thereon. The cover comprises multiple candle recesses, an intended location of a message slot, a sample text message that may be placed within the slot, and recessed side portions for ease in lifting the cover. A limited number of candle recesses are illustrated in this figure-for the purposes of example only, as the cover of the present invention may include up to 110 such recesses, in order to accommodate birthdays of persons of all ages.

Part Numbers: cover 12, cover top surface 12T, cover side surface 12S, cake 14, cake decorations 14A, candle recesses 16, candles 18, candle holders 20, message slot 22, letters for spelling out message 24, cover indentations 26, bottom piece or tray 28, and lifting handles 30.

### DETAILED DESCRIPTION OF THE PREFERRED EMBODIMENT

Referring to FIG. 1, which is a front, three-quarter perspective view of a cake on which the cover of present invention may be placed, with the bottom piece of the invention illustrated thereon; and FIG. 2, which is a front, three-quarter perspective view of a cake with the cover of the present invention thereon, illustrating multiple candle recesses, the intended location of the message slot, and recessed side portions for ease in lifting the cover (for the purposes of example only):

The drawings depict the cover 12, cover top surface 12T, cover side surface 12S, cake 14, cake decorations 14A, candle recesses 16, candles 18, candle holders 20, message slot 22, letters for spelling out message 24, cover indentations 26, bottom piece or tray 28 and lifting handles 30.

More particularly, the germ protective cake cover device for use in a freezer comprises a generally transparent cover which is molded in the shape of a common cake. The cover further comprises a top surface and side surface. The device also comprises a bottom piece upon which the cake sits. The bottom piece is of a shape corresponding to that of the cover. The bottom piece functions to receive the cover, effectively enclosing the cake therein. The bottom piece further comprises a locking means which functions to allow the cover to engage the bottom piece in a tight and secure fashion.

The top surface further comprises at least one round aperture therein. The apertures function to allow the cake under the protective cake cover to receive and hold candles therein. The apertures are of a suitable diameter to allow the candle to penetrate the cake under the cover while the candle is contained in it's own individual candle holder, while also preventing the melted wax from contacting the top of the cake. The cover is constructed from freezer-proof materials wherein the cake under said cover may be stored in a freezer until needed.

Furthermore, the cover comprises a top surface and single side surface in the event it is cylindrical in configuration, or multiple side surfaces in the event it is square or rectangular. Importantly, the cover top surface comprises a quantity of recessed round apertures in the range of one to one hundred ten. This allows the cover of the present invention to accommodate the ages of all persons celebrating birthdays.

The recessed round apertures may function to receive and hold candle holders, functioning to provide an effective means to hold candles neatly. Alternatively, the recessed round apertures may be manufactured sufficiently wide in diameter to allow candle holders to pass therethrough and into the cake beneath the cover.

Unlike the prior art, the top surface further comprises a message slot in a generally centered position thereon. The message slot is generally rectangular in shape and functions to slidingly receive a previously-determined celebratory text message panel therein.

In the preferred embodiment, a plurality of previously-determined text phrase panels are included in the assembly, for insertion into the message slot. In addition, in the preferred mode the assembly further comprises a plurality of letters of the alphabet that may be manually configured by a user into names and messages for insertion into the message slot. Thus, the user can spell out names of celebrants or honorees, as well as spell out their own unique messages.

It should also be noted that in the preferred embodiment, the cover side portion comprises a plurality of indentations which function to facilitate lifting and lowering of the cover.

Also included in the assembly is a bottom piece upon which the cake sits. The bottom piece is of a shape corresponding to that of the cover, and the bottom piece functions to receive the cover, effectively enclosing the cake therein. Both the cover and bottom piece of the assembly may be manufactured of a durable plastic or polymeric material for durable construction and effective sealing at minimal cost.

Moreover, the bottom piece may further comprise a plurality of handle members, which function to facilitate lifting and lowering of the assembly.

Furthermore, in the preferred mode of production, the assembly of the present invention is freezer proof in nature, functioning to allow a cake held within the assembly to be stored in a freezer for extended periods of time.

Regarding the general versatility of the present invention, in all modes of manufacture the cover and bottom piece may be of a shape selected from the group consisting of round, oval, square and rectangular. In addition, the assembly may be manufactured in a variety of sizes in order to accommodate varying sizes of common cakes.

Moreover, the cover and bottom piece bear colors, graphics, and indicia thereon. Such colors, graphics, and indicia may relate to a previously-determined celebratory theme, such as a birthday, anniversary, wedding, bar mitzvah, retirement or graduation, if desired by the manufacturer and user.

Thus, in total, the assembly functions to protect the cake from germs from individuals blowing out candles thereon, while providing a means to view the cake and functioning to provide a storage container for the cake.

With regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A germ protective cake cover device for use in a freezer, comprising:
a generally transparent cover molded in the shape of a common cake, the cover further comprising a top surface and side surface, and;
a bottom piece upon which the cake sits, the bottom piece of a shape corresponding to that of the cover, the bottom piece functioning to receive the cover, effectively enclosing the cake therein, the bottom piece further comprising a locking means which functions to allow the cover to engage the bottom piece in a tight and secure fashion, and;
the top surface further comprising at least one round aperture therein, which function to allow the cake under the protective cake cover to receive and hold candles therein, said apertures of a suitable diameter to allow the candle to penetrate the cake under the cover while the candle is contained in it's own individual candle holder, while also preventing the melted wax from contacting the top of the cake, and;
further comprising said cover constructed from freezer-proof materials wherein said cake under said cover may be stored in a freezer until needed.

2. A method for using a germ protective cake cover device in a freezer, said method comprising:
(a) placing a cake in the device of claim 1;
(b) placing at least one candle through the at least one aperture in the cover of said device of claim 1, penetrating the cake therein;
(c) placing the cake and the device of claim 1 into a freezer until needed.

3. The device of claim 1 further comprising a plurality of indentations in said cover which function to facilitate lifting and lowering of the cover.

4. The device of claim 1 further comprising at least one handle member on said cover, which functions to facilitate lifting and lowering of the cover.

5. The device of claim 1 further comprising wherein the cover and bottom piece are of a shape selected from the group consisting of round, oval, square and rectangular.

6. The device of claim 1 further comprising wherein the cover and bottom piece of the assembly are manufactured of a durable plastic or polymeric material.

7. The device of claim 1 further comprising a plurality of letters of the alphabet that may be configured by a user into names on said cover.

8. The device of claim 1 further comprising a message slot disposed on said cover to receive messages as desired by the user.
